(19) United States
(12) Patent Application Publication
(10) Pub. No.: US 2013/0217360 A1
(43) Pub. Date: Aug. 22, 2013

(54) MESSAGING CONTROL SYSTEM

(71) Applicants: Stephen Dakin, London (GB); James Day, London (GB)

(72) Inventors: Stephen Dakin, London (GB); James Day, London (GB)

(21) Appl. No.: 13/814,662

(22) PCT Filed: Aug. 3, 2011
(86) PCT No.: PCT/GB11/51475

§ 371 Date: Mar. 25, 2013

(30) Foreign Application Priority Data
Aug. 3, 2010 (GB) 1013048.2

(51) Int. Cl. H04W 4/14

(52) U.S. Cl. CPC H04W 4/14
USPC 455/411; 455/466

(57) ABSTRACT

A messaging control system is described that is arranged to control the transmission of mobile messages—such as SMS messages—originating from third party content providers to user mobile devices. The messaging control system comprises a database for storing user preference data, a user interface to receive preference data from a user and a rules engine. The rules engine is arranged to receive a transmission request originating from a third party content provider to transmit a mobile message to the mobile device of the user. The rules engine is further arranged to transmit a response to the transmission request based on the outcome of a rules processing step identifying how the mobile message is to be handled.

### FIELD OF THE INVENTION

The present invention relates to a messaging control system arranged to control the transmission of mobile messages, such as SMS or MMS messages. In particular, the messaging control system is arranged to control the transmission of mobile messages originating from third party content providers which are sent to user mobile handsets.

### BACKGROUND

SMS has been a popular technology developed from the beginning of the 1980's. It consists of sending messages of no more than 160 characters per message, including spaces, generally between mobile devices such as mobile telephone handsets owned by an end user (i.e. a mobile subscriber—an owner of one or more handsets with accompanying Mobile Subscriber Integrated Services Digital Network Number [MSISDN] —commonly known as a mobile telephone number). In addition to SMS, other mobile message formats, such as MMS (Multimedia Messaging Service) exist. Where the term SMS is used below, it will be understood that this can be interchanged with other mobile messaging formats such as MMS.

The mobile messaging industry has opened up the technology as a delivery and revenue generation method with massive success. In particular, the delivery of Premium and Marketing messages, as will be described in greater detail below, enable revenue to be generated by third parties through charge-levying or advertising channels.

However, the delivery of unsolicited mobile messages to user handsets is undesirable. In particular, users may receive messages that they do not want and/or to which they have not subscribed. In the case of unsolicited marketing messages, these can be an annoyance, and furthermore, in the case of unsolicited premium message, users are charged for receiving the mobile messages. To stop such messages being received, a user may need to lodge a complaint with parties to the mobile message delivery process.

Furthermore, the transmission of unnecessary mobile messages on a mobile network uses up system resources such as bandwidth and storage space, both on the network and on mobile handsets. It is an object of the present invention to alleviate such problems.

The problems and complexities of the current system will now be described in more detail, with specific reference to the mobile message delivery parties, the current operation of the premium and marketing SMS industry and the current process of lodging a complaint about unwanted mobile messages.

Mobile Message Delivery Parties:

Mobile Network Operator [MNO]

The mobile network operators provide mobile services to their customers including voice, SMS and data to name a few. They are responsible for assigning new short-codes to customers and vetting the applications to ensure quality of services for their end-users. They provide the interfaces necessary for Value Added Service Providers to connect to the SMS Servers [SMSC] and Billing Platforms in order to allow VASPs to send and receive SMS and charge premiums directly to an end-users mobile phone bill. They make money from the services in a profit sharing model.

Aggregator (Service Provider)

An aggregator is connected to all the main MNOs SMS and Billing platforms. They in turn expose interfaces that will allow a third party content provider to connect to the aggregator to enable SMS traffic and billing across all MNOs.

Content-Provider

A content-provider typically uses an aggregator to send its content/marketing/value added services and apply a premium using the aggregators' interfaces. They will run marketing campaigns and harvest mobile telephone numbers that would like to opt-in to receive such SMS services using a number of methods, advertising on TV/Radio and Web to name a few.

Regulator

The SMS service industry is regulated by the Office of Communications or, as it is more often known, Ofcom. It is an independent regulator and competition authority for the communication industries in the United Kingdom. Ofcom was initially established in the Office of Communications Act 2002, but received its full authority from the Communications Act 2003.

Under the Communications Act 2003, Ofcom has responsibility for the regulation of premium rate services. In December 2007 it was confirmed that PhonepayPlus will act as the agency which carries out the day-to-day regulation of the Premium Rate Service market on Ofcom's behalf. PhonepayPlus (previously known as ICSTIS) regulates phone-paid services in the UK. These are the premium rate goods and services that you can buy by charging the cost to your phone bill and pre-pay account.

In respect to Marketing based SMS services, the Information Commissioner's Office is responsible for the Data Protection Act 1998 whereby consumers have the right to opt-out of receiving direct marketing communications.

TABLE 1
MNO, MVNO & Aggregators associated
with SMS Services in the UK

| In the UK, the | | |
|---|---|---|
| market leading | | |
| Mobile Network | | Mobile SMS, Billing & |
| Operators | Mobile Virtual Network | Content Aggregators |
| [MNO] are: - | Operators using MNOs | connected to MNOs |
| Vodafone | Virgin (T-Mobile) | 2ergo |
| Orange | Tesco Mobile (O₂) | clickatell mobile messaging |
| O2 | BT Mobile Home | Crosby Communications |
| T-Mobile | (T-Mobile) | Limited |
| Hutchinson 3G | Dot-Mobile (Vodafone) | Dialogue |
| [Three] | Kingston Communica- | Echovox |
| | tions (O2) | Enpocket |
| | One. Tel (Vodafone) | Ericsson |
| | Sainsburys Telecom (O2) | Esendex |
| | | Fly Txt |
| | | g8wave |
| | | Hybyte |
| | | mBlox Limited |
| | | MChex Ltd |
| | | Mindmatics |
| | | Minick |
| | | Mobile 365 |
| | | Mobile Interactive Group |
| | | Mobizar Ltd |
| | | MX Telecom |
| | | Netsize |
| | | Opera Telecom |
| | | Reach-Data |
| | | Telecom One |
| | | Wireless Information |
| | | Network Limited |
| | | Zamano |
| | | ZIM EPL |

SMS Industry

Commercially, the SMS industry breaks down into two areas:—
Premium SMS
Marketing SMS

Premium SMS

Short messages may be used to provide premium rate services to end-users of a telephone network.

Mobile terminated short messages can be used to deliver digital content such as news alerts, financial information, logos and ring tones. In 2002 the ringing tone business globally had exceeded one billion dollars of service revenues and in 2008 the ‘basic ringing tone’ industry was worth nearly 5 billion dollars.

The Value-added service provider [VASP] providing the content submits the message to the mobile operator's SMSC(s) either directly to a Mobile Network Operator [MNO] or via Aggregators using a TCP/IP protocol such as the short message peer-to-peer protocol [SMPP] or the External Machine Interface [EMI]. The SMSC delivers the text using the normal Mobile Terminated delivery procedure. The end-users are charged extra for receiving this premium content, and the amount is typically divided between the mobile network operator and the VASP either through revenue share or a fixed transport fee.

Mobile originated short messages may also be used in a premium-rated manner for services such as tele-voting (X-Factor® for example). In this case, the VASP providing the service obtains a short code from the telephone network operator, and end-users send texts to that number. The payouts to the carriers vary by carrier and the percentages paid are greatest on the lowest priced premium SMS services. Most information providers should expect to pay about 45% of the cost of the premium SMS up front to the carrier. The submission of the text to the SMSC is identical to a standard MO Short Message submission, but once the text is at the SMSC, the Service Centre identifies the Short Code as a premium service. The SC will then direct the content of the text message to the VASP, typically using an IP protocol such as SMPP or EMI. End-users are charged a premium for the sending of such messages, with the revenue typically shared between the network operator and the VASP. Limitations of short codes include the limitation to national borders (short codes have to be activated in each country where the campaign takes place), as well as being expensive to connect with mobile operators.

Marketing SMS

Marketing on a mobile phone has become increasingly popular ever since the rise of SMS (Short Message Service) in the early 2000s in Europe and some parts of Asia when businesses started to collect mobile phone numbers and send off wanted (or unwanted) content.

Over the past few years SMS has become an advertising channel in some parts of the world. This is because unlike email over the public internet, the carriers who police their own networks have set guidelines and best practices for the mobile media industry (including mobile advertising). The IAB (Interactive Advertising Bureau) and the Mobile Marketing Association, as well, have established guidelines and are evangelising the use of the mobile channel for marketers.

Mobile marketing via SMS has expanded rapidly in Europe and Asia as a new channel to reach the consumer. SMS initially received negative media coverage in many parts of Europe for being a new form of spam as some advertisers purchased lists and sent unsolicited content to consumer's phones; however, as guidelines are put in place by the mobile operators, SMS has become the most popular branch of the Mobile Marketing industry with several 100 million advertising SMS sent out every month in Europe alone.

Over the past few years mobile short codes have been increasingly popular as a new channel to communicate to the mobile consumer. Brands have begun to treat the mobile shortcode as a mobile domain name allowing the consumer to text message the brand at an event, in store and off any traditional media.

How a Premium Service is Typically Run

SMS services typically run off a short code. Short codes are 4 or 5 digit numbers that have been assigned by all the mobile operators for the use of brand campaign and other consumer services. The mobile operators vet every application before provisioning and monitor the service to make sure it does not diverge from its original service description.

Current Problems in the Public Domain Relating to SMS Service Include:—

For End-Users:
No central place for specifying preferences with respect to inbound SMS services
Receipt of unrequested SMS (No opt-in)
   a Premium—Where a premium is charged to the end-user
   a Marketing—No charge but can be considered a nuisance
Clarity of current subscriptions services based on Premium SMS per MSISDN

For Operators:
No capability to offer preference setting on behalf of their subscribers
Limited auditing and view of traffic for discussion with the end-user

For Aggregators:
Limited knowledge of end-user preferences
Limited capability to react to changes in live services
Limited subscription flow checking and maintenance

For Regulators:
Delay in service audit for discussion with SMS senders & Consumers
Delay in audit for Subscription services
Reactive message content compliance checking
Delay in subscription flow checking

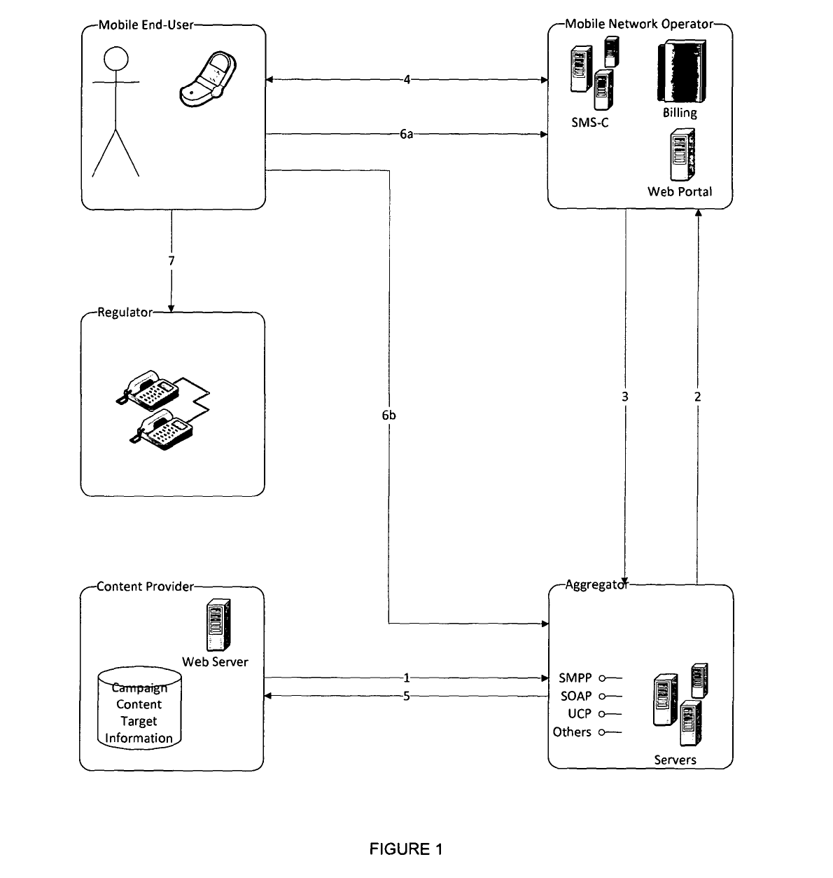

Referring to FIG. 1, there is shown the current process of sending an SMS message, and complaint channels if a user receives an unwanted SMS. The steps in FIG. 1 are as follows:
1. Content-Provider sends SMS (Marketing or Premium) to Aggregator specifying MSISDN and Operator
2. Aggregator sends the message to the MSISDN via the correct Operator and makes a charge if premium
3. Operator accepts message and responds to say sent
4. End-user receives the SMS
5. Content-Provider receives confirmation that SMS was sent

If the message was not requested or a service not opted-in to, the end-user can complain. The lines 6a & 6b and 7 show the possible channels to complain on.
6. Either:—
   a. End-user can complain to the Operator who will forward them on to the Aggregator
   b. End-user will complain direct to the Aggregator and receive a refund if due
7. Or directly with 6a or 6b the end-user complains to the Regulator (if enough complaints occur, an investigation will commence)
This process by which a user attempts to control the mobile messages received by his/her handset can be slow, inefficient and complicated.

It is an object of the present invention to alleviate the above-mentioned problems at least in part.

### DISCLOSURE OF THE INVENTION

According to a first aspect of the present invention there is provided a messaging control system arranged to control the transmission of mobile messages such as SMS or MMS messages originating from third party content providers to user mobile devices, the messaging control system comprising:
a database arranged to store user preference data comprising:
   identity data, such as an MSISDN, uniquely identifying a mobile device of the user; and
   subscription information defining a user selected preference in relation to subscription by the identified mobile device to at least one of a plurality of subscription categories;
a user interface arranged to receive the preference data from a user; and
a rules engine arranged for:
   receiving a transmission request originating from a third party content provider to transmit a mobile message to the mobile device of the user;
   categorising the mobile message as belonging to one of the plurality of subscription categories;
   processing a set of rules to determine how the mobile message is to be handled based on its assigned subscription category and the user preference data of the user for which the mobile message is intended; and
   transmitting a response to the transmission request based on the outcome of the rules processing step identifying how the mobile message is to be handled.

It will be understood that third party content providers may provide services instead of or as well as content.

It will also be understood that subscription by the identified mobile device to at least one of a plurality of subscription categories may also comprise subscription to at least one of a plurality of service categories.

Preferably, the messaging control system is arranged to handle mobile messages having the intended recipient of the message identified by identity data, such as an MSISDN, uniquely identifying a mobile device and hence it's associated user.

Preferably, the messaging control system is arranged to interface with one or more authorised message intermediaries, such as Aggregators and/or Mobile Network Operators, the rules engine being arranged to receive a transmission request originating from a third party via the one or more intermediaries and transmit a response to the respective intermediary identifying how the mobile message is to be handled.

Preferably, the user interface is a graphical user interface.

Preferably, the graphical user interface is presented to a user via a web portal.

Preferably, the messaging control system is arranged to receive user preference data from a user via a mobile message sent from the mobile device of the user.

Preferably, the messaging control system further comprises a mobile message traffic logger for providing a log in the database containing information about transmission requests received by the rules engine and associated responses to the transmission requests.

Preferably, the traffic logger logs data including times and dates when the rules engine receives transmission requests and when associated responses to the transmission requests are sent.

Preferably, the traffic logger logs information identifying parties such as message originators, intermediaries and intended recipients, involved in the transmission of a mobile message.

Preferably, the traffic logger is arranged to receive queries from authorised users and in response return selected information contained within the log.

Preferably, the returned selected information is restricted in accordance with an authorisation level of the authorised user.

Preferably, the messaging control system is arranged to generate default user preference data in response to receiving a transmission request to transmit a mobile message to a mobile device with which there is no user preference data already associated.

Preferably, the messaging control system is arranged to send a message containing message control information to a mobile device for which a transmission request has been received and with which there is no user preference data already associated.

Preferably, the message control information comprises authorisation and access information.

Preferably, the messaging control information comprises a user-interactable link to allow authorised access by a user of the mobile device to the user interface, thereby allowing user control of the user preference data stored in the database.

Preferably, the user selected preference includes a preference for or against subscription by the mobile device to at least one of the plurality of subscription categories.

Preferably, the messaging control system is arranged to transmit a message to an originator of a mobile message, and/or an intermediary, that the mobile message is to be denied onward transmission to a mobile device for which the message is intended as a result of determining that the mobile message is categorised in a subscription category for which the mobile device is not registered and/or is registered as having a subscription against.

Example embodiments of the invention will now be described:

### SPECIFIC DESCRIPTION

The messaging control system will consists of five components which work together to provide a solution to enable improved regulation, quality of service and reduced overheads in the Short Message Service [SMS] commercial industry. Hereinafter, the messaging control system according to embodiments of the present invention will also be referred to as a Mobile Preference Service (MPS).

The messaging control system will consist of the following components:
List Distribution
Industry Standard Interfaces (Interface)
Unique Software Rules Engine [USRE]
Organic Database
Graphical User Interfaces [GUI]
End-user SMS control

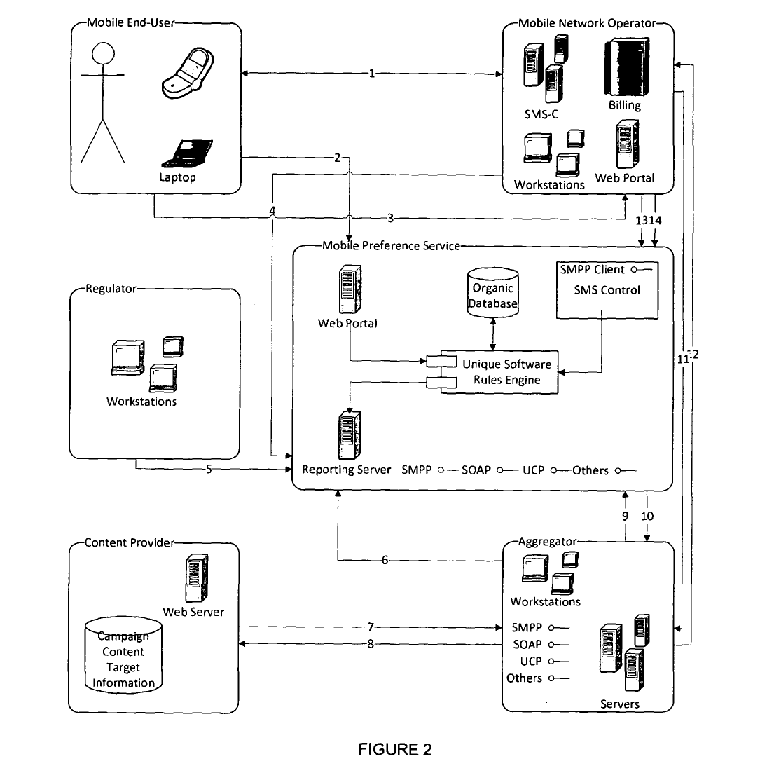

A high-level over view of the operation of the messaging control system will now be provided with reference to the steps shown in FIG. 2:
1. Mobile Operator sends/receives SMS from SMSC to/from End-Users Handset with MSISDN
2. End-user browses MPS Web Portal to set service preferences registered against their MSISDN(s)
3. End-user browses their operator Web Portal, which hosts the MPS preference web portal, to set service preferences registered against their MSISDN(s)
4. Operators view a User Interface to interrogate traffic
5. Regulators view a User Interface to interrogate traffic
6. Aggregators view a User Interface to interrogate traffic
7. Content provider submits a message (Marketing/Premium) to an aggregator for sending via an Operator
8. Aggregator responses to requests
9. Aggregator check preferences with the MPS
10. MPS responses to requests
11. Operator responses to requests
12. Aggregator requests SMS submission and Billing of accounts
13. SMS preference controlling messages delivered to MPS
14. Operator Web Portal request for Preference Hosting within their own portal

List Distribution

Whilst the embodiment in its entirety will provide very granular preference capability, the embodiment will allow high-level, short development, preference exposure by producing lists of preferences. The preferences will be against MSISDN and show those who have decided to Opt-Out of all Marketing and/or Premium Rated Services.

The delivery can be through formatted files like CSV or as a database export from the MPS systems.

Database/Datafile cleansing would also be catered for by using the lists as a service to Content-Providers and Service Providers alike.

Industry Standard Interfaces (Interface)

One component of the MPS is the Industry Standard Interfaces allowing content providers and aggregators to query the preferences of end-users whilst declaring to the system unknown end-users and services; The responses to the queries will be given as a result of the processing of input values given in the request by the second MPS component, the USRE.

Unique Software Rules Engine [USRE]

The USRE will compare the input values with preferences set by the end user (if any) and respond based on a rule set incorporating industry regulation. Should any of the inputs be new to the USRE, those inputs become new data in the third component of the MPS, the Organic Database, allowing current and future responses from the Interface.

Organic Database

The organic database will contain no initial data and be enriched by the queries run against the interface controlled by the USRE and by the interaction of the end-user setting preferences in the fourth component of the MPS, the GUI or by the fifth component—the End-user SMS Control.

Graphical User Interfaces [GUI]

The GUI will allow the end-user to control their preference over all Premium and Marketing SMS and MMS services and should specific services attempt to send SMS to the end-user, allow the end-user to set the preference for that specific service. By expressing a preference, the Organic Database information is updated and the USRE will give a modified response based on any changes to the end-user preferences. Similar to the Telephone preference service it allows end-users to decide to opt-out/opt-in or customise the flow of SMS to their handsets. It will also allow an end-user to see in one place the preference settings for each of their mobile handsets and give an overview of what they could potentially be costing each month.

The Graphical User Interfaces (GUI) supports:—
An interface for the Regulator to view traffic for the follow parameters and information; any Date, any MSISDN, any service, any aggregator, on any operator and allow the regulator to manipulate the traffic by the said parameters.
An interface for the Operator to view traffic for the follow parameters and information; any Date, any MSISDN, any service, any aggregator but only on their network and allow the operator to manipulate the traffic by the said parameters.
An interface for the Aggregator to view traffic for the follow parameters and information; any Date, any MSISDN, any service, only through their own aggregation but on any operator and allow the aggregator to manipulate the traffic by the said parameters.

End-User SMS Control

The fifth component of the MPS allows an end-user to set preferences without using the GUI by sending SMS messages with specific content to set their preferences. This SMS message will be converted in software under the control of the USRE will update the content of the Organic Database.

The following provides a more in-depth description of the capability of each component:

List Distribution

To provide a mechanism to respect mobile end-user preferences, without development and the richer capability of the MPS, Aggregators and content-providers can obtain lists or databases generated from the preferences registered with MPS. These lists/databases can then sanitise Marketing and Premium SMS Targeting lists.

The inverse service can be provided whereby target marketing and premium lists or databases can be sent to the MPS for sanitising against the same data.

The preference information will be high-level and not have the full real-time capability of the MPS Interfaces but will allow Aggregators and Content-Providers high-level of confidence in respecting the preferences of the Mobile End-User preferences.

Sanitising a list or database will involve checking each record provided against the MPS database and removing or marking the record depending on the Mobile End-Users' preference and desired method of the requesting body (Aggregator or Content-Provider).

Industry Standard Interfaces (Interface)

The interfaces will be developed to mimic existing Mobile Network Operator interfaces which include but are not limited to SMPP, XML over HTTP & UCP.

The computerised message that would normally be sent to the mobile network operator will first be sent to MPS system to receive a response in the native language including use of error codes. If that response is positive (That the end user has expressed no preference or has a preference to receive that message) then the Aggregator can submit the message to the MNO. If the response is negative, the aggregator then reflects that response to the Content-Provider.

In addition, interfaces will be exposed for administration of the user-accounts including:—
Access for MNOs help desk operators to control preferences on behalf of their end users.
Stop notification for Operators/Aggregators to indicate that an end-user has responded to a service with STOP.

Unique Software Rules Engine [USRE]

The logic provided by the USRE will be controlled by the end-user directly or by proxy, using an Operator representative or someone from the Mobile Preference Service authorised to undertake actions on behalf of the end-user.

The end-user will be able to set their preferences on varying levels to include:—
Service
Category
Content-Provider
Aggregator
All (Premium or Marketing or both)

There is logic that will allow the end-user to set a preference at the service level that will then allow the same categorised service to reflect that preference and vice-versa.

### Example

Service View

TABLE 1
Preferences by Service

| Aggregator | Services | Category | Preference |
|---|---|---|---|
| Agg1 | Football Scores | Football | On |
| Agg2 | Football Tables | Football | On |
| Agg3 | 101 Recipes | Food | On |
| Agg1 | Horoscope Daily | Living | On |

Category View

TABLE 2
Preferences by Category

| Aggregator | Category | Services | Preference |
|---|---|---|---|
| | Football | | On |
| Agg1 | | Football Scores | On |
| Agg2 | | Football Tables | On |
| | Food | | On |
| Agg3 | | 101 Recipes | On |
| | Living | | On |
| Agg1 | | Horoscope Daily | On |

Aggregator View

TABLE 3
Preferences by Aggregator

| Aggregator | Category | Services | Preference |
|---|---|---|---|
| Agg1 | | | On |
| | Football | Football Scores | On |
| | Living | Horoscope Daily | On |
| Agg2 | | | On |
| | Football | Football Tables | On |
| Agg3 | | | On |
| | Food | 101 Recipes | On |

Example Logic 1:

Starting with Table 1, 2 and 3, Changing preference for service Football Tables to Off in Service View will result in the following category table:—

Category View

TABLE 4
Preferences by Category

| Aggregator | Category | Services | Preference |
|---|---|---|---|
| | Football | | On |
| Agg1 | | Football Scores | On |
| Agg2 | | Football Tables | Off (Service Preference) |
| | Food | | On |
| Agg3 | | 101 Recipes | On |
| | Living | | On |
| Agg1 | | Horoscope Daily | On |

Example Logic 2:

Starting with Table 1, 2 and 3, Changing preference for category Football in Category View will result in the following service table:—

| Aggregator | Services | Category | Preference |
|---|---|---|---|
| Agg1 | Football Scores | Football | Off (Category Preference) |
| Agg2 | Football Tables | Football | Off (Category Preference) |
| Agg3 | 101 Recipes | Food | On |
| Agg1 | Horoscope Daily | Living | On |

Example Logic 3:

Starting with Table 1, 2 and 3, Changing preference for Aggregator Agg 1 in Aggregator View will result in the following service table:—

| Aggregator | Services | Category | Preference |
|---|---|---|---|
| Agg1 | Football Scores | Football | Off (Aggregator |
| | | | Preference) |
| Agg2 | Football Tables | Football | On |
| Agg3 | 101 Recipes | Food | On |
| Agg1 | Horoscope Daily | Living | Off (Aggregator |
| | | | Preference) |

Organic Database

The database will be built using the queries that are executed against it and enriched by the interaction of the end-user or an end-user representative.

As an aggregator makes a query against the mobile preference service the query is logged, the response is sent and a number of actions depending on the query take place.

New MSISDN

When a query is sent against a new MSISDN, that MSISDN has an account created to contain it and those are then stored within the database ready for the owners to contact MPS and set their preferences.

New Service

When a query is sent for a new service recognised by a new Short-Code, a New Alias, New Content-mask or New Identification it will create the service in the database and be visible to only the MSISDN it was requested against.

Graphical User Interfaces [GUI]

In order to present the information stored about preferences and the traffic associated, the MPS will expose several graphical interfaces.

The interfaces can be categorised for use by Mobile End-Users, Service Providers and Operators and Regulators.

For Mobile End-Users alongside the ability to set their preferences as previously mentioned, they will have the ability to view the traffic sent to their MSDISN, associated costs of the traffic/service if any. Views can be grouped to allow multiple MSISDNs to be viewed together, then drilled down to MSISDN level, then by Service and then by each message instance.

For Service Providers and Operators they will see the traffic information only pertinent to those services they are responsible for. Their views will allow them to view by Service or MSISDN and drill down to the other detail (Service or MSISDN) to give a view of the services operating. The view of a service may include traffic from another aggregator should the Premium and Informational messages have different origins. The Operators will have a higher level view incorporating the service providers.

Regulators have a very similar view to the operators but have no restriction across networks. They will be able to see views by Service, MSISDN or Service Provider and in turn data filtered by MSISDN, Service and Aggregator until each message instance.

End-User SMS Control

For greater access, the end-users will be able to control some aspects of the MPS system by sending SMS messages to MPS.

Examples, which are not limiting, of such messages and their affect on preferences are:—

| | |
|---|---|
| STOP ALL | Sets all marketing and premium rated service prefer- |
| | ences to “NO GO” |
| STOP MKG | Sets all marketing service preferences to “NO GO” |
| STOP PRM | Sets all premium service preferences to “NO GO” |
| STOP | Sets all Football service preferences to “NO GO” |
| FOOTBALL | |
| <<SMS message | Set the preference for the service that sent the SMS |
| received>> | message to “NO GO” |
| Forwarding an | |
| SMS sent from a | |
| content-provider | |
| to MPS | |
| START ALL | Sets all marketing and premium rated service prefer- |
| | ences to “GO” |
| START MKG | Sets all premium service preferences to “GO” |
| START PRM | Sets all marketing service preferences to “GO” |
| START | Sets all Football service preferences to “GO” |
| FOOTBALL | |

End-User Perspective Examples

Without the MPS, the following processes takes place:
Person A that does not know the Mobile Preference Service and receive a premium or marketing SMS message but doesn't want any more and has no internet access.

This person is currently only able to stop a service by these methods.
Responding to the original message by SMS with content “STOP”
Contact the Aggregator (Both the regulator and Operator will guide an end-user to the aggregator) by telephone only
Contact the Content-Provider direct (Not always obvious who that is) by telephone only

If the SMS message carried a premium, the aggregator will process a refund unless they can prove the SMS was requested (Opt-in).
Person B that does not know the Mobile Preference Service and receives a premium or marketing SMS message but doesn't want any more and has internet access.

This person is currently only able to stop a service by these methods.
Responding to the original message by SMS with content “STOP”
Contact the Aggregator (Both the regulator and Operator will guide an end-user to the aggregator) by telephone or email
Contact the Content-Provider direct (Not always obvious who that is) by telephone or email

If the SMS message carried a premium, the aggregator will process a refund unless they can prove the SMS was requested (Opt-in).

The MPS provides alternative ways of controlling the delivery of such Marketing or Premium mobile messages:
Person C that does know the Mobile Preference Service and receives a premium or marketing SMS message but doesn't want any more and has no internet access.

This person is able to stop a service by these methods.
Send (Forward) the SMS to the Mobile Preference Service to opt out of the service
   Using Authentication
Send an SMS (with specific keywords) to the Mobile Preference Service to opt out of all Premium or Marketing SMS
   Using Authentication
Responding to the original message by SMS with content “STOP”
Contact the Aggregator (Both the regulator and Operator will guide an end-user to the aggregator) by telephone only
Contact the Content-Provider direct (Not always obvious who that is) by telephone only
Contact the Mobile Network Operator by telephone only

If the SMS message carried a premium, the aggregator will process a refund unless they can prove the SMS was requested (Opt-in).
Person D that does know the Mobile Preference Service and receives one or more premium or marketing SMS messages but doesn't want any more and has internet access.

This person is able to stop a service by these methods.
Send (Forward) each SMS to the Mobile Preference Service to opt out of the service
   Using Authentication
Send an SMS (with specific keywords) to the Mobile Preference Service to opt out of one or opt out of all Premium or Marketing SMS
   Using Authentication
Responding to the original message by SMS with content “STOP”
Navigates to the MPS website/portal and authenticates to log into the personalised preference pages.
   Within that page the end-user can:—
      Stop all Marketing Messages
      Stop all Premium Messages
      Do both of the above
      Stop a specific service
   Marking the service as not preferred, each time an aggregator attempts to send a message for this service to the end-users MSISDN, the respond will be negative and the Aggregator will be told not to send.
Contact the Aggregator (Both the regulator and Operator will guide an end-user to the aggregator) by telephone only or email.
Contact the Content-Provider direct (Not always obvious who that is) by telephone or email
Contact the Mobile Network Operator by telephone only

If the SMS message carried a premium, the aggregator will process a refund unless they can prove the SMS was requested (Opt-in).
Person E that does know the Mobile Preference Service and receives two premium or marketing SMS message and doesn't want one of them and has internet access.
   Send (Forward) an SMS to the Mobile Preference Service to opt out of the service
      Using Authentication
   Send an SMS (with specific keywords) to the Mobile Preference Service to opt out of one or opt out of all Premium or Marketing SMS
      Using Authentication
   Navigates to the MPS website/portal and authenticates to log into the personalised preference pages.
      Within that page the end-user can:—
         Stop all Marketing Messages
         Stop all Premium Messages
         Do both of the above
         Stop a specific service
      Marking the service as not preferred, each time an aggregator attempts to send a message for this service to the end-users MSISDN, the respond will be negative and the Aggregator will be told not to send.
   Contact the Aggregator (Both the regulator and Operator will guide an end-user to the aggregator) by telephone only or email.
   Contact the Content-Provider direct (Not always obvious who that is) by telephone or email
   Contact the Mobile Network Operator by telephone only
   If the SMS message carried a premium, the aggregator will process a refund unless they can prove the SMS was requested (Opt-in).

If the SMS message carried a premium, the aggregator will process a refund unless they can prove the SMS was requested (Opt-in).
Person B is interested in seeing how many services have attempted to contact him since registering with the Mobile Preference Service.

This person is able to view all services and their attempts to send an SMS message by logging on to the MPS website/portal.
Navigates to the MPS website/portal and authenticates to log into the personalised preference pages.
   Within that page the end-user can:—
      View all services that have attempted to send an SMS
Navigates to the mobile network operator's portal and authenticates to log into the personalised preference pages.
Contact the Mobile Network Operator by telephone only
Person A would like to change their preference to allow Marketing or Premium SMS services and has no internet access.

This person is able to restart a service by one method.
Send an SMS (with specific keywords) to the Mobile Preference Service to opt in to all Premium or Marketing SMS
   Using Authentication
Contact the Mobile Network Operator by telephone only
Person B would like to change their preference to allow Marketing or Premium SMS service and has internet access.

This person is able to restart a service by logging on to the MPS Website./Portal.
Navigates to the MPS website/portal and authenticates to log into the personalised preference pages.
   Within that page the end-user can:—
      Change their preferences
Navigates to the mobile network operator's portal and authenticates to log into the personalised preference pages.
Send an SMS (with specific keywords) to the Mobile Preference Service to opt in to all Premium or Marketing SMS
   Using Authentication
Contact the Mobile Network Operator by telephone only
Person C is now interested in an SMS stream that he previously preferred not to receive and revisits the Mobile Preference Service.

This person is able to restart a stream by logging on to the MPS Website./Portal.
Navigates to the MPS website/portal and authenticates to log into the personalised preference pages.
   Within that page the end-user can:—
      Change their preferences
Navigates to the mobile network operator's portal and authenticates to log into the personalised preference pages.
Send an SMS (with specific keywords) to the Mobile Preference Service to opt in to a stream of Premium or Marketing SMS
   Using Authentication
Contact the Mobile Network Operator by telephone only
Person A has two mobile handsets and would like to use the Mobile Preference Service for both.

This person is able to add another MSISDN to his account by logging on to the MPS Website./Portal.
Send an SMS (with specific keywords) to the Mobile Preference Service to join handsets to an account
   Using Authentication
Navigates to the MPS website/portal and authenticates to log into the personalised preference pages.
   Within that page the end-user can:—
      Add an MSISDN to the account (Using authentication)
      Persist the same preferences across both handsets
Navigates to the mobile network operator's portal and authenticates to log into the personalised preference pages. (Assuming they are both on the same Network)
Contact the Mobile Network Operator by telephone only
Person C would like to use the Mobile Service for all his families' mobile handsets.

This person is able to add another MSISDN to his account by logging on to the MPS Website./Portal.
Send an SMS (with specific keywords) to the Mobile Preference Service to opt in to all Premium or Marketing SMS
   Using Authentication
Navigates to the MPS website/portal and authenticates to log into the personalised preference pages.
   Within that page the end-user can:—
      Add an MSISDN to the account (Using authentication)
      Add an MSISDN to a collection
      Set preferences for each collection
Navigates to the mobile network operator's portal and authenticates to log into the personalised preference pages. (Assuming they are both on the same Network)
Contact the Mobile Network Operator by telephone only

Content-Provider/Aggregator Perspective Examples

Without the MPS, the following processes takes place:
Content-Provider has purchased a database of MSISDN for marketing their content to. They load the data and make one or more requests per MSISDN to send content.

There is no checking of numbers being sent Marketing/Zero cost SMS messages.
Content-Provider creates a database of MSISDN for sending Premium Rate SMS.

The regulated method of sending Premium Rated SMS is to gain Opt-in first. There is no single point to check the validity of the opt-in mechanism by Content nor Service providers. If a service is provided fully by one Aggregator, they may well have Opt-In checking functionality.

### ADVANTAGES

For End-Users

For Cost-Control Reasons

Single Point to manage inbound SMS and Subscription services showing costs and quantities

Control of marketing options on free SMS

Control over number subscriptions with the ability to stop, restart (if still running) and beginning Premium Subscriptions.

Control over cost of subscriptions by information on frequency and charges per messages per service

Audit of SMS/Subscription history, giving information on when the subscription started and messages were attempted to be sent.

Single point for controlling mobile service when incorporated into Mobile Network Operators' portals alongside the rest of their services.

Parents that want to have visibility/control of their children's mobile services

Business owners of company mobile phones could use such a service in the negative way of ensuring certain services are blocked

For Relevance/Anti-Spam Reasons

People who do want such services can ensure they get just the services they prefer

Some people actively prefer to be prompted with marketing/premium messages, without having to search for services individually.

For Personal Choice Reasons

Users change their minds/preferences from time to time, and this service would be updated within a far shorter time than traditional/existing methods

Therefore if someone was, for instance, going away on holiday, they could disable their settings (Holiday Mode) so they don't get charged expensive roaming fees

They might decide that certain products are no longer relevant/acceptable to receive and so can easily identify what it is they want to stop

For Aggregators and Content Providers

Reduced calls to Operator SMSC for sending messages against the end-users preference

Operating services that respect consumer choice and having dynamic awareness

3rd Party Audit trail for services allowing visibility across multiple aggregators

Discussions with Consumer & regulators using common reports and views on the reports

Subscription flow and maintenance is enabled across a service with both informational and premium aspects being shown to the Premium Rate service provider

Reduce possible fines incurred by actively considering the preferences of potential recipients of their products, so this service could almost be paying for itself

Opening up of potential market; if people have indicated YES to a product, they just get that valuable data without having to buy yet another list of mobile phones which often get obtained from questionnaires/surveys and get out of date quickly

Using a more directed, targeted, intelligent service means they will get a higher rate of return on their message sending, rather than a scattergun approach

The effort spent in checking quality/accuracy of data is put onto MPS, a single point of focus

For Operators

Reduced load on the SMSC due to reduced SPAM messaging

Provision of the preference service within their Customer Services Portal

Provision of API to enable integration with the Customer Services Telephonists

Reduced complaint phone calls from customers querying items on bills that the operator can't directly respond to.

For Regulators

Instant service audit capabilities with reports and views on sms traffic that can be shared with End-Users, Service Providers and if necessary, Operators.

Audit for subscription services across Service Providers showing for each service the informational messages and the Premium rate messages

Subscription flow checking ensuring that SMS messages are sent in the correct order according to regulation, Informational messages before premium rate messages.

Message content compliance checking using comparison algorithms

Variations

Non-mobile telephone numbers
Telephone
Technology has progressed to allow SMS messages to be sent to Landlines. The MPS service could allow accounts created on Land Line numbers to allow the preferences to be declared.
The Telephone Preference Service could integrate their database to allow real-time querying of Landline/Mobile numbers for SMS and Voice Marketing calls.
Facsimile

Email preferences

Post/Mail Preferences

### GLOSSARY

SMS Short Message Service
MT Mobile Terminated. SMS message sent to the mobile handset
MO Mobile Originated. SMS message sent from the mobile handset
Mobile An electronic device used for mobile telecommunications
MSISDN Mobile Subscriber Integrated Services Digital Network Number
MNO Mobile Network Operator
SMS-C/SMSC Short Message Service Center
VASP Value Added Service Provider
SMPP Simple Message Peer-To-Peer
EMI External Machine Interface
USRE Unique Software Rules Engine—MPS developed software rules engine
GUI Graphic User Interface

1. A messaging control system arranged to control the transmission of mobile messages such as SMS messages originating from third party content providers to user mobile devices, the messaging control system comprising:
a database arranged to store user preference data comprising:
identity data, such as an MSISDN, uniquely identifying a mobile device of the user; and
subscription information defining a user selected preference in relation to subscription by the identified mobile device to at least one of a plurality of subscription categories;
a user interface arranged to receive the preference data from a user; and
a rules engine arranged for:
receiving a transmission request originating from a third party content provider to transmit a mobile message to the mobile device of the user;
categorising the mobile message as belonging to one of the plurality of subscription categories;
processing a set of rules to determine how the mobile message is to be handled based on its assigned subscription category and the user preference data of the user for which the mobile message is intended; and
transmitting a response to the transmission request based on the outcome of the rules processing step identifying how the mobile message is to be handled.

2. A messaging control system as claimed in claim 1, arranged to handle mobile messages having the intended recipient of the message identified by identity data, such as an MSISDN, uniquely identifying a mobile device and hence it's associated user.

3. A messaging control system, as claimed in claim 1 arranged to interface with one or more authorised message intermediaries, such as Aggregators and/or Mobile Network Operators, the rules engine being arranged to receive a transmission request originating from a third party via the one or more intermediaries and transmit a response to the respective intermediary identifying how the mobile message is to be handled.

4. A messaging control system according to claim 1, wherein the user interface is a graphical user interface.

5. A messaging control system according to claim 4, wherein the graphical user interface is presented to a user via a web portal.

6. A messaging control system according to claim 1, arranged to receive user preference data from a user via a mobile message sent from the mobile device of the user.

7. A messaging control system according to claim 1, further comprising a mobile message traffic logger for providing a log in the database containing information about transmission requests received by the rules engine and associated responses to the transmission requests.

8. A messaging control system according to claim 7, wherein the traffic logger logs data including times and dates when the rules engine receives transmission requests and when associated responses to the transmission requests are sent.

9. A messaging control system according to claim 7, wherein the traffic logger logs information identifying parties such as message originators, intermediaries and intended recipients, involved in the transmission of a mobile message.

10. A messaging control system according to claim 7, wherein the traffic logger is arranged to receive queries from authorised users and in response return selected information contained within the log.

11. A messaging control system according to claim 10, wherein the returned selected information is restricted in accordance with an authorisation level of the authorised user.

12. A messaging control system according to claim 1, arranged to generate default user preference data in response to receiving a transmission request to transmit a mobile message to a mobile device with which there is no user preference data already associated.

13. A messaging control system according to claim 1, arranged to send a message containing message control information to a mobile device for which a transmission request has been received and with which there is no user preference data already associated.

14. A messaging control system according to claim 13, wherein the messaging control information comprises a user-interactable link to allow authorised access by a user of the mobile device to the user interface, thereby allowing user control of the user preference data stored in the database.

15. A messaging control system according to claim 1, arranged to transmit a message to an originator of a mobile message, and/or an intermediary, that the mobile message is to be denied onward transmission to a mobile device for which the message is intended as a result of determining that the mobile message is categorised in a subscription category for which the mobile device is registered as having a subscription against.
